(19) United States
(12) Patent Application Publication
(10) Pub. No.: US 2017/0136681 A1
(43) Pub. Date: May 18, 2017

(54) ELECTROMAGNETIC PROCESSING MODULE EQUIPPED WITH THERMALLY REGULATED CONFINEMENT ELEMENTS

(71) Applicant: SIDEL PARTICIPATIONS, Octeville-sur-Mer (FR)

(72) Inventors: Yoann LAHOGUE, Octeville-sur-Mer (FR); Guy FEUILLOLEY, Octeville-sur-Mer (FR)

(21) Appl. No.: 15/325,560

(22) PCT Filed: Jul. 17, 2015
(86) PCT No.: PCT/EP2015/066446

§ 371 Date: Jan. 11, 2017

(30) Foreign Application Priority Data
Jul. 23, 2014 (EP) 14306192.7

(51) Int. Cl. B29C 49/64; H05B 3/00; B29C 35/08

(52) U.S. Cl. CPC B29C 49/6418; B29C 35/0805; H05B 3/0057; B29C 2035/0822; B29K 2067/003

(57) ABSTRACT

An electromagnetic processing module includes: a main body having a front face; a light emitting assembly including a plurality of light emitting sources, the light emitting assembly being such mounted onto the main body as to radiate frontwards; a fluidic circuit provided within the main body for thermal regulation of the light emitting assembly; and at least one confinement element made of a material opaque to the emitting light and having a confinement face exposed to the emitted light. The confinement element is mounted onto the main body so as to be in thermal contact therewith, whereby thermal regulation of the confinement face is provided by the fluidic circuit.

### FIELD OF THE INVENTION

The invention generally relates to the electromagnetic processing of hollow bodies made of plastic material, in order to heat such hollow bodies.

More specifically, the invention relates to an electromagnetic heating of parisons of containers (such as bottles, jars or flasks), performed by passing them through processing unit, equipped with a plurality of sources of electromagnetic radiation, the term “parison” referring either to a preform, obtained by injecting a raw material into an injection mold, or to an intermediate container (or hollow body) obtained by blow molding a preform, which intermediate container requires a complementary thermal processing for any reason.

### BACKGROUND OF THE INVENTION

One possible application is the heating of parisons under the form of preforms in view of forming containers by stretch blow molding the preforms after they have been heated.

Although the conventional technique of heating parisons by means of tubular incandescent halogen lamps radiating according to Planck's law over a continuous spectrum is the most widely used to date, an alternative technology has recently emerged, based on the use of monochromatic or quasi-monochromatic radiation (such as lasers), emitting in the infrared range.

The performance and properties (particularly optical precision) of laser heating, which are superior to those of halogen heating, make it possible to achieve a faster and more selective heating of the parisons.

French patent application FR 2 982 790 and the equivalent PCT application WO 2113/076415 (both to Sidel Participations) both disclose a processing unit including a plurality of heating modules each provided with a plurality of infrared sources. More specifically, each heating module comprises:
a main body,
a light emitting assembly including a plurality of infrared light emitting sources,
a fluidic circuit provided within the main body for thermal regulation of the light emitting assembly;
at least one confinement element mounted onto the main body, said confinement element being made of a material opaque to infrared light and having a confinement face exposed to infrared light (either from the heating module to which it is attached, or from another heating module facing the latter).

The confinement element serves to reflect the infrared light toward the parisons and/or to limit dispersion of the infrared light outside the processing unit.

Despite its performances, there is still a need for enhancing the efficiency of the processing unit. More precisely, it is desired to maintain temperature of the whole processing unit at a low level, preferably close to atmospheric temperature, in order to limit thermal inertia and increase security of the processing unit, and also to minimize radiation interferences from the confinement elements.

US 2012/326345, US 2010/072673 (both to Sidel Participations) and DE 10 2005 061334 (Advanced Photonics Tech AG) also disclose units to heat objects.

### SUMMARY OF THE INVENTION

It is an object of the invention to provide an electromagnetic processing unit having increased security.

It is another object of the invention to provide an electromagnetic processing module and an electromagnetic unit having a low thermal inertia.

It is yet another object of the invention to provide an electromagnetic module provided with confinement elements which may be maintained at a temperature close to atmospheric temperature.

It is therefore provided, according to a first aspect, an electromagnetic processing module including:
a main body having a front face,
a light emitting assembly including a plurality of light emitting sources, the light emitting assembly being such mounted onto the main body as to radiate frontwards,
a fluidic circuit provided within the main body for thermal regulation of the light emitting assembly;
at least one confinement element made of a material opaque to the emitted radiation and having a confinement face exposed to the emitted radiation, said confinement element being mounted onto the main body so as to be in thermal contact therewith, whereby thermal regulation of the confinement face is provided by the fluidic circuit.

According to various embodiments, taken either separately or in combination:
the confinement element is fixed to the main body by means of screws or any other fixation means providing tight contact;
one confinement element is a reflector frame surrounding the light emitting assembly, and one confinement face of the reflector frame is an optically reflecting face oriented frontwards;
the reflector frame has a rear edge opposite the reflecting face, said rear edge being in contact with the front face of the main body;
one confinement element is a lower reflector mounted below the light emitting assembly, and one confinement face of the lower reflector is an optically reflecting face oriented upwards;
the lower reflector is mounted onto the main body through a setting plate provided with means for adjusting vertical position of the lower reflector with respect of the main body, said setting plate serving as thermal bridge between the main body and the lower reflector;
the setting plate has an optically reflecting face oriented frontwards;
one confinement element is an upper absorber mounted above the light emitting assembly, and one confinement face of the upper absorber is an optically absorbing face oriented frontwards;
the upper absorber has an optically reflective lower edge oriented downwards, positioned in the vicinity of an upper edge of the light emitting assembly;
the light emitting assembly is received in a hollow front housing formed in the front face of the main body;
the fluidic circuit comprises at least one intake channel formed in the main body, said intake channel opening, on the one hand, in the front housing through an intake hole and, on the other hand, on a rear face of the main body through an inlet port;
the fluidic circuit comprises at least one discharge channel formed in the main body parallel to the intake channel, said discharge channel opening, on the one hand, in the front housing through a discharge hole and, on the other hand, on the rear face of the main body through an outlet port;
the fluidic circuit comprises a pair of discharge channels formed on each side of the intake channel;
the light emitting sources are designed for emitting in the infrared range, such as infrared laser diodes, e.g. VCSEL diodes.

It is further proposed an electromagnetic processing unit for processing parisons made of plastic, said processing unit comprising a series of adjacent processing modules as disclosed hereinbefore.

The above and other objects and advantages of the invention will become apparent from the detailed description of preferred embodiments, considered in conjunction with the accompanying drawings.

### BRIEF DESCRIPTION OF THE DRAWINGS

In the drawings:

FIG. 1 is a perspective view of a processing unit for processing parisons, including a series of adjacent processing modules.

FIG. 2 is a transversal cut view of the processing unit of FIG. 1.

FIG. 3 is a perspective, exploded front view of a processing module the processing unit of FIG. 1 is equipped with.

FIG. 4 is a perspective, exploded rear view of the processing module of FIG. 1.

FIG. 5 is a perspective front view of an assembled processing module.

FIG. 5B is a view similar to FIG. 5, showing the processing module in a different configuration.

FIG. 6 is a front view of the processing module of FIG. 5.

FIG. 7 is a detail cut view of the processing module of FIG. 6, taken along line VII-VII.

FIG. 8 is a detail cut view of the processing module of FIG. 6, taken along line VIII-VIII.

FIG. 9 is a detail cut view of the processing module of FIG. 6, taken along line IX-IX.

FIG. 10 is a perspective detail cut view of the processing module of FIG. 6, taken along line X-X.

FIG. 11 is a perspective detail cut view of the processing module of FIG. 6, taken along line XI-XI.

### DETAILED DESCRIPTION

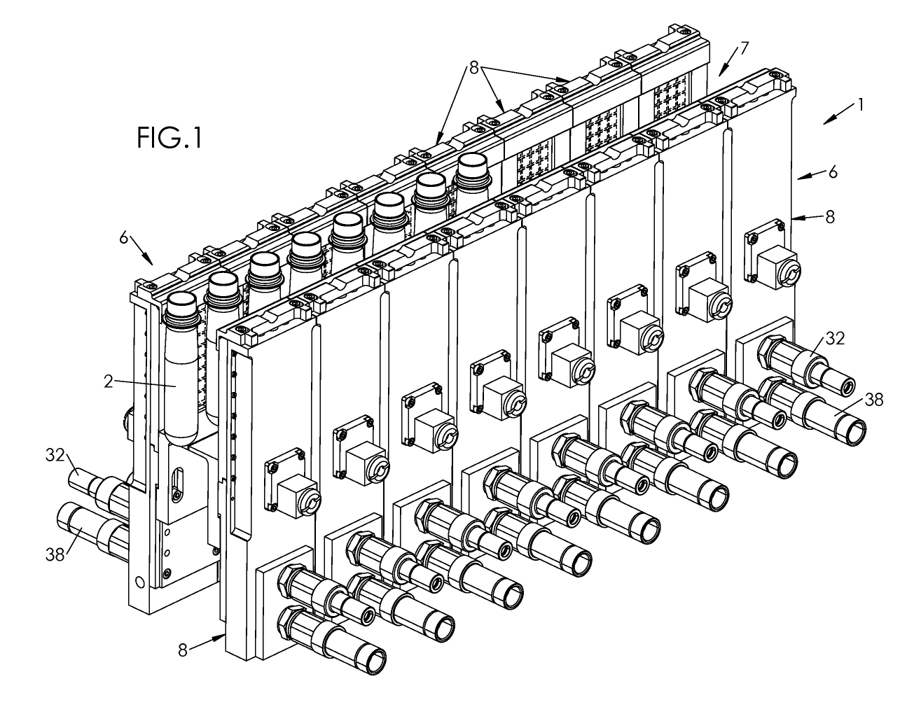

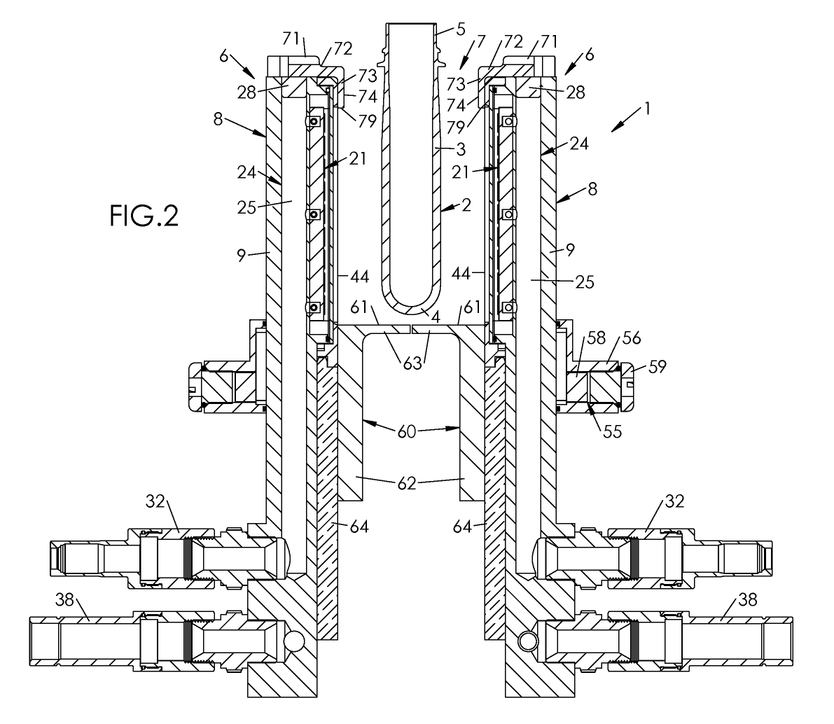

Depicted on FIG. 1 and FIG. 2 is an electromagnetic processing unit 1 for the processing (such as the heating or the decontamination) of parisons 2 made of a plastic material. In the illustrated example, the parisons 2 are preforms (e.g. made of polyethylene terephthalate or PET) intended, when heated (and therefore softened), to undergo a blowing or stretch-blowing operation in a mold to form containers such as bottles or flasks.

The preform shown to depict a parison 2 has a substantially cylindrical body 3 closed at one end by a hemispherical bottom 4 and being extended, at an opposite end, by a neck 5, which neck is generally used to carry it and is open to form the mouth of the final container (as depicted on FIG. 1 and FIG. 2).

Instead of a preform, the parison 2 might be an intermediate container, already known, obtained during a previous blow molding or stretch blow molding step of a preform. Like a preform, such intermediate container would comprise a body 3 closed at one end by a bottom 4 and being extended, at an opposite end, by a neck 5 (which is also the neck of the preform.

Each parison 2 (here each preform) is driven in motion along a path which, in the depicted example, is linear but which may take any other shape, including an arc of a circle.

The processing unit 1 comprises a pair of parallel sidewalls 6 facing each other, which extend vertically along the path of the parisons 2, on either side thereof, and which together define a cavity 7 in which the parisons 2 pass.

At least one (and preferably each) sidewall 6 comprises a series of similar electromagnetic processing modules 8 mounted adjacent to one another.

Each processing module 8 includes a main body 9 preferably made of a single piece of a thermally conductive material, such as a steel alloy, a copper alloy or an aluminum alloy.

As will be disclosed hereinafter, the processing module 8 includes other components mounted on the main body 9, which therefore provides a support function for those components. The components are fixed to the main body 9 either directly or indirectly through interface elements.

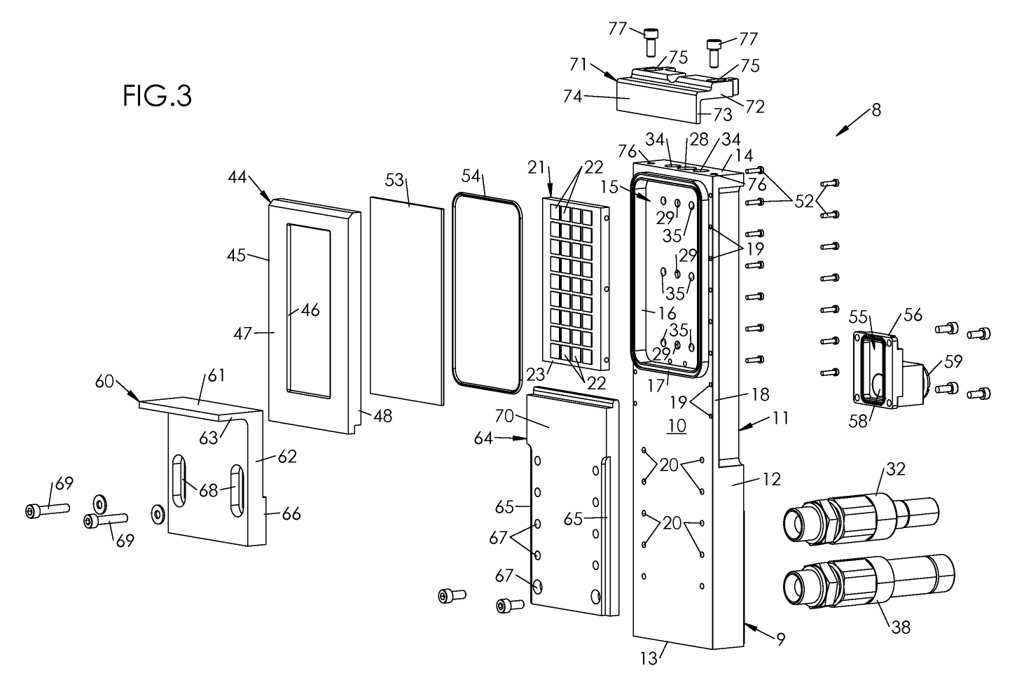

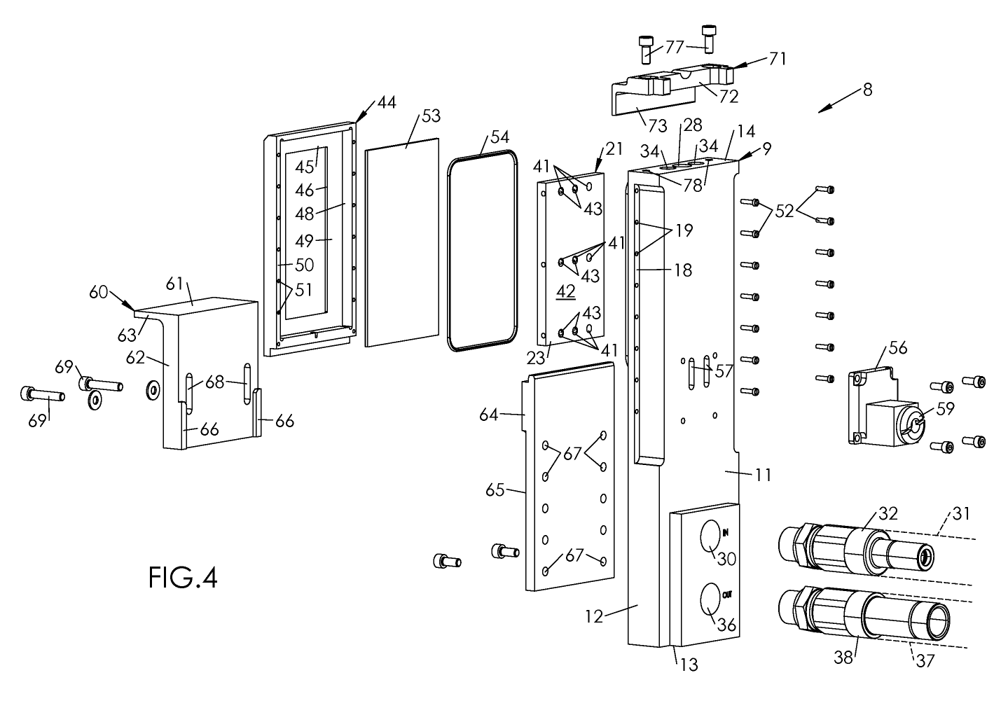

As depicted on FIG. 3 and FIG. 4, which are exploded perspective views of a processing module 8, the main body 9 is substantially prismatic of shape, and has a front face 10 which, in operation (see FIG. 1), is oriented towards the cavity 7, i.e. towards the parisons 2 (respectively the represented preforms).

The main body 9 also has a rear face 11, lateral faces 12, a lower edge 13 and an upper edge 14.

In the following, any surface oriented in the same direction as the front face 10 is described as oriented frontwards. On the contrary, any surface oriented in a direction opposite the front face 10 is described as oriented backwards. Any surface oriented towards the lower edge 13 of the main body 9 is described as oriented downwards, whereas any surface oriented towards the upper edge 14 of the main body 9 is described as oriented upwards.

In a preferred embodiment, the main body 9 comprises a hollow front housing 15 formed in the front face 10 adjacent the upper edge 14 thereof. As depicted on FIG. 3, the front housing 15 is surrounded by a rib 16 protruding from the front face 10. The rib 16 is preferably rectangular in shape and has rounded corners. A continuous groove 17 is formed in a front edge of the rib 16.

In one embodiment illustrated in FIG. 3 and FIG. 4, each lateral face 12 of the main body 9 is at least partly cut out to define a lateral protruding rib 18. This rib 18 is provided with a series of through holes 19 opening on the front face 10. The main body 9 is also provided with a series of threaded blind holes 20 drilled in the front face 10 beneath the front housing 15.

The processing module 8 also comprises a light emitting assembly 21 mounted onto the main body 9 and including a plurality of light emitting sources (each of microscopic dimensions and therefore not visible in the drawings).

More precisely, the sources preferably emit monochromatically or pseudo-monochromatically. In one embodiment, wherein the processing unit 1 is a heating unit designed for the thermal conditioning of the parisons 2 for the manufacturing of containers therefrom, the light emitting sources are designed for emitting in the infrared range. In another embodiment, wherein the processing unit 1 is a decontamination unit designed for the decontamination of the parisons 2, e.g. in view of a subsequent aseptic filling, the light emitting sources are designed for emitting in the ultraviolet range. Several wavelengths or ranges (such as infrared and ultraviolet) may also be combined.

In theory, a monochromatic source is an ideal source, emitting a sinusoidal wave of a single frequency. In other words, its frequency spectrum is composed of a single ray of zero spectral width (Dirac).

In practice, such a source does not exist, a real source being at best quasi-monochromatic, i.e. its frequency spectrum extends over a band of spectral width that is small but not zero, centered on a main frequency where the intensity of the radiation is maximum. However, it is customary to imprecisely refer to such a real source as monochromatic. Moreover, a source emitting quasi-monochromatically over a discrete spectrum comprising several narrow bands centered on distinct main frequencies is called “pseudo-monochromatic” and is also referred to as a multimode source.

In one embodiment, wherein the processing unit 1 is a heating unit, the light emitting sources may be infrared laser diodes.

One possible organization form of the sources is a matrix 22, as in the depicted example. The or each matrix 22 may be a matrix of vertical-cavity surface-emitting laser (VCSEL) diodes, known to provide a high density of sources (up to several tens or hundreds of thousands per square inch). In such an arrangement, the matrix 22 may emit several mW per square inch. With a view to heat parisons 2, the wavelength of infrared emitted light may be of about 1 μm, substantially corresponding to a peak of energy absorbance of PET and hence providing a quick and efficient heating of the parisons 2.

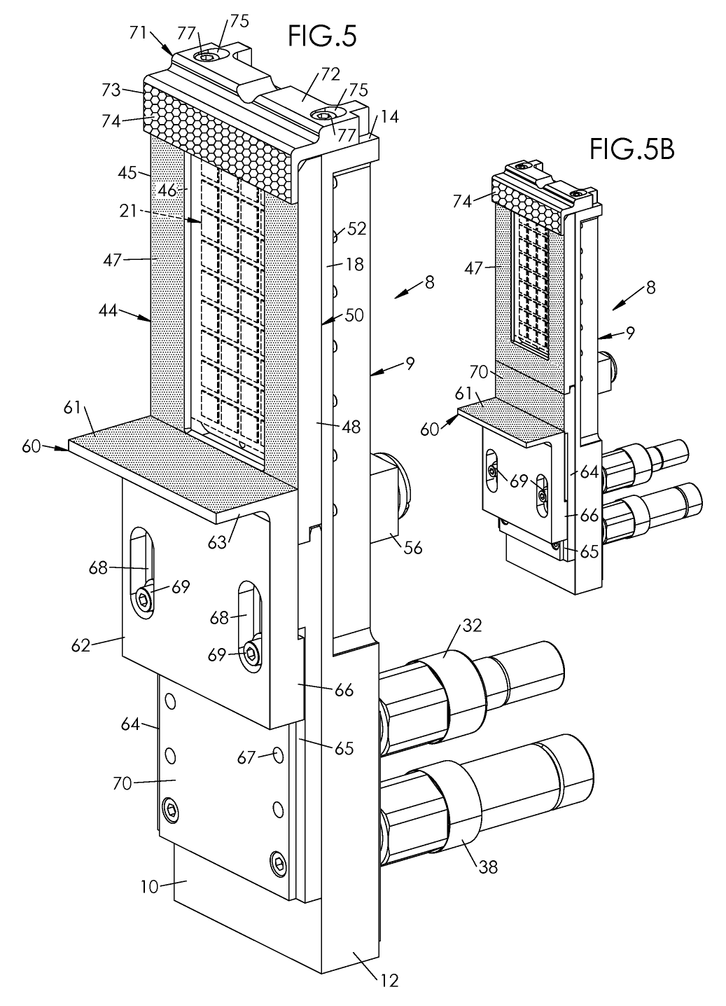

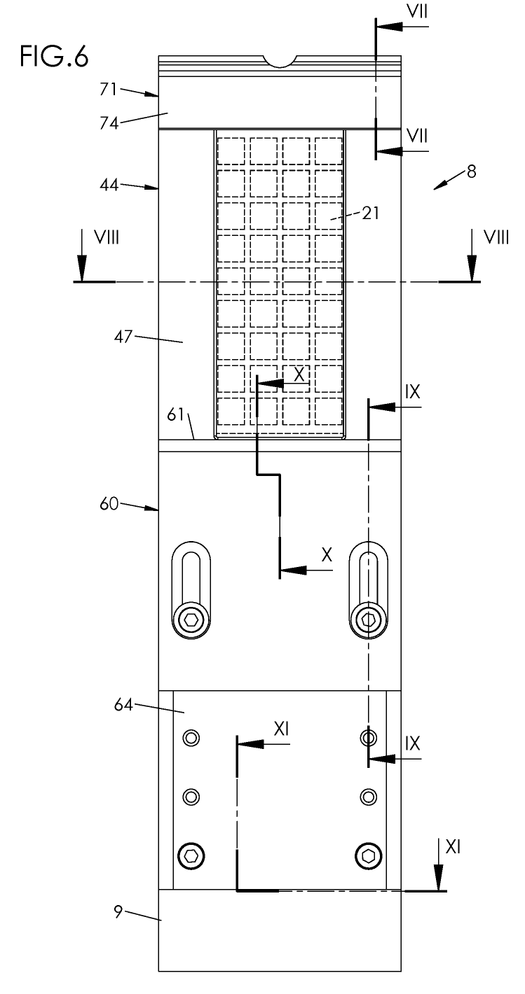

In the depicted example, and more precisely in FIG. 3, FIG. 4 and FIG. 5, the emitting assembly 21 comprises a plurality of such matrixes 22 mounted on a common substrate 23 and in turn organized to form a larger matrix. In FIG. 3, the emitting assembly 21 comprises thirty-six adjacent matrixes 22 but this number is arbitrary.

The light emitting assembly 21 is such mounted onto the main body 9 as to radiate frontwards. In practice, the light emitting assembly 21 is received in the front housing 15. The light emitting assembly 21 is smaller than the front housing 15 and thinner than the rib 16. The light emitting assembly 21 is therefore completely received within the front housing 15, the rib 16 extending frontwards beyond the light emitting assembly 21. The light emitting assembly 21 is tightly fixed to the main body by means of screws or any other suitable means.

In operation, the light emitting assembly 21 produces heat which, if not removed, would decrease its efficiency. The light emitting assembly 21 therefore needs to be cooled, and more precisely maintained to a substantially constant temperature.

To that end, the processing module 8 comprises a fluidic circuit 24 provided within the main body 9 for thermal regulation of the light emitting assembly 21. The cooling fluid may simply be pure water, but any other suitable fluid may be used, such as water with an additive e.g. ethylene glycol or propylene glycol, or even a gas such as cooled air or nitrogen.

In the depicted example, the fluidic circuit 24 comprises at least one intake channel 25 and at least one discharge channel 26 formed within the main body 9.

The intake channel 25 extends vertically within the main body 9 from a lower end 27 close to the lower edge 13 of the main body 9, to an opposite upper end close to the upper edge 14 of the main body 9. In practice, the intake channel 25 may be formed by vertically drilling the main body 9 from the upper edge 14, at which the intake channel 25 is closed by a tap 28.

The intake channel 25 opens, on the one hand, in the front housing 15 through an intake hole 29 drilled in the front face 10. On the other hand, the intake channel 25 opens on the rear face 11 of the main body 9 through an inlet port 30. In the example of FIG. 3, several intake holes 29 may be drilled in the front face 10, thereby allowing high fluid rate and uniform cooling of the light emitting assembly 21.

Cooling fluid is supplied to the fluidic circuit 24 by an intake duct 31 (in dotted lines on FIG. 4) via an intake nozzle 32 connected to the inlet port 30.

The or each discharge channel 26 extends also vertically within the main body 9 aside (and preferably parallel to) the intake channel 25, from a lower end 33 close to the lower edge 13 of the main body 9, to an opposite upper end close to the upper edge 14 of the main body. In practice, the discharge channel 26 may be formed by vertically drilling the main body 9 from the upper edge 14, at which the discharge channel 26 is closed by a tap 34.

The discharge channel 26 opens, on the one hand, in the front housing 15 through a discharge hole 35 drilled in the front face 10. On the other hand, the discharge channel 26 opens on the rear face 11 of the main body 9 through an outlet port 36. In the example of FIG. 3, several pairs of discharge holes 35 may be drilled in the front face 10 on each side of the intake holes 29.

The cooling fluid is discharged from the fluidic circuit 24 by a discharge duct 37 (in dotted lines on FIG. 4) via a discharge nozzle 38 connected to the outlet port 36.

In the depicted example, the inlet port 30 and outlet port 36 are located one above the other, although this configuration may be regarded as optional.

In a preferred embodiment, the fluidic circuit 24 comprises a pair of discharge channels 26 formed on each side of the intake channel 25. In the depicted example, the intake channel 25 is centrally formed in the main body 9, and the discharge channels 26 are formed between the intake channel 25 and the lateral faces 12 of the main body 9.

At their lower ends 33, the discharge channels 26 commonly open to the outlet port 36 through a transversal linking channel 39.

As depicted on FIG. 8, the light emitting assembly 21 is provided with a fluid distribution circuit 40 formed within the substrate to spread the fluid flow behind the matrixes 22 of light sources. In the illustrated embodiment, the fluid distribution circuit 40 comprises holes 41 drilled in a rear face 42 of the substrate 23, linked by at least one transversal distribution channel 43.

The processing module 8 further comprises at least one confinement element, mounted onto the main body 9 and made of a material opaque to infrared light and having a confinement face exposed to infrared light (either coming from the same processing module 8 or from another processing module, such as a module 8 of the opposite sidewall 6).

The term “confinement” is used to encompass two possible optical properties of an element, material or surface: optical reflection; optical absorption. In theory, a reflective surface provides specular reflection when a ray of light coming from a single direction is reflected into an outgoing ray going to a single direction, whereas an absorbing surface provides absorption when rays of light coming from any direction are not reflected at all but completely absorbed within the surface.

Practically however, an element, material or surface may reasonably be regarded as reflective when it reflects most part of incident light, whereas an element, material or surface may reasonably be regarded as absorbing when it absorbs most part of incident light.

Depending upon its configuration, material and positioning, the confinement element(s) serve(s) to:
reflect towards the cavity 7 at least part of the radiation it receives, in order to minimize energy loss and hence increase performances of the processing unit 1,
and/or absorb at least part of the radiation it receives, in order to avoid energy dispersion outside the cavity 7, mostly for the sake of personnel safety.

In either case, a part of incident light is absorbed within the confinement element, therefore providing energy—and hence heat—thereto.

It is desired to remove at least part of that heat from the confinement element, in order to maintain the latter at a temperature where:
thermal dissipation from the confinement element(s) (and hence undesired infrared radiation within the cavity 7) is minimized,
thermal fatigue of the confinement element(s), when switching the processing module 8 from a switched off state to an operational state (or vice-versa), is minimized;
thermal inertia of the confinement element(s)—and hence of the processing module 8 and processing unit 1—is minimized when switching the processing module 8 on.

To do so, the or each confinement element is mounted on the main body 9 so as to be in thermal contact therewith, whereby thermal regulation of the confinement face is provided by the fluidic circuit 24.

In the depicted example, the processing module 8 comprises several confinement elements.

One confinement element is a reflector frame 44 surrounding the light emitting assembly 21. As illustrated on FIG. 3 and FIG. 4, the reflector frame 44 has a rectangular panel 45 provided with a central opening 46 of rectangular contour for the passage of light emitted by the light emitting assembly 21.

The confinement face of the reflector frame 44 is an optically reflecting front face 47 of the panel 45, oriented frontwards.

The reflector frame 44 is preferably made of a thermally conductive material, such as a steel alloy, a copper alloy or an aluminum alloy.

The optically reflective properties of the front face 47 may be achieved by a polishing or a coating operation, e.g. by physical vapor deposition (PVD). The coating material may be silver, platinum, aluminum or even gold. The front face 47 serves to reflect radiation from the processing modules 8 of the opposite sidewall 6 towards the parisons 2 (as illustrated by the dashed lines of FIG. 8), thereby increasing efficiency of the processing unit 1. For the sake of clarity, the reflecting front face 47 is made visible in FIG. 5 by means of a shaded pattern.

As depicted on FIG. 4, the reflector frame 44 is provided with a support rim 48 which protrudes rearwards from a rear face 49 of the panel 45, opposite the front face 47. The rim 48 defines a rear edge 50 opposite the front face 47, drilled with a series of threaded blind holes 51.

The reflector frame 44 is mounted onto the main body 9 and fixed thereto e.g. by means of screws 52 (or any other suitable fixation means providing tight contact, such as a thermal glue) which come in helical cooperation with the blind holes 51 through the through holes 19 in the lateral rib 18. Tightening the screws 52 against the lateral rib 18 provides tight contact between the rear edge 50 of the rim 48 and the front face 10 of the main body 9. Such a tight contact ensures thermal contact between the main body 9 and the reflector frame 44. Therefore, thermal regulation of the main body 9 provides thermal regulation of the reflector frame 44, and more specifically of the front face 47 thereof. It shall be noted that, since the contact between the reflector frame 44 and the main body 9 is mainly provided in the lateral ribs 18, this is where most of the thermal exchanges occur. As the lateral ribs 18 are closer to the discharge channels 26 than to the intake channel 25, most of the heat extracted from the reflector frame 44 goes to the fluid flowing in the discharge channels 26, thereby preserving the fluid flowing in the intake channel 25, which is hence more efficient in cooling the light emitting assembly 21.

In one preferred embodiment, disclosed in the drawings and more precisely in FIG. 3 and FIG. 4, the processing module 8 further comprises a transparent window panel 53 made e.g. of quartz, interposed between the rear face 49 of the reflector frame 44 and the main body 9. Advantageously, a resilient sealing joint 54 (e.g. made of natural or synthetic rubber) is sandwiched between the window panel 53 and the main body 9. More precisely, the sealing joint 54 is received within the groove 17 formed in the rib 16 protruding from the front face 10 of the main body 9. Such assembly is clearly depicted on FIG. 8.

The window panel 53 and sealing joint 54 provide watertightness to the front housing 15, thereby limiting the risk of pollution of the light emitting assembly 21, due to moisture from air.

In order to withdraw moisture from the front housing 15, the processing module 8 may therefore include a desiccation chamber 55. In the depicted example, the desiccation chamber 55 is formed within an add-on case 56 mounted on the rear face 11 of the main body 9 (e.g. by means of screws).

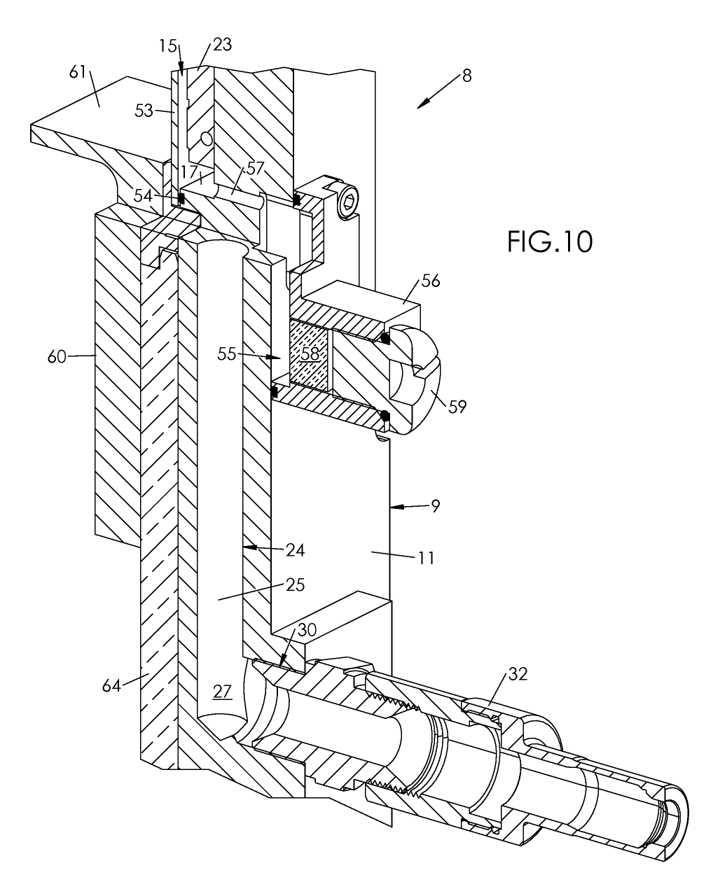

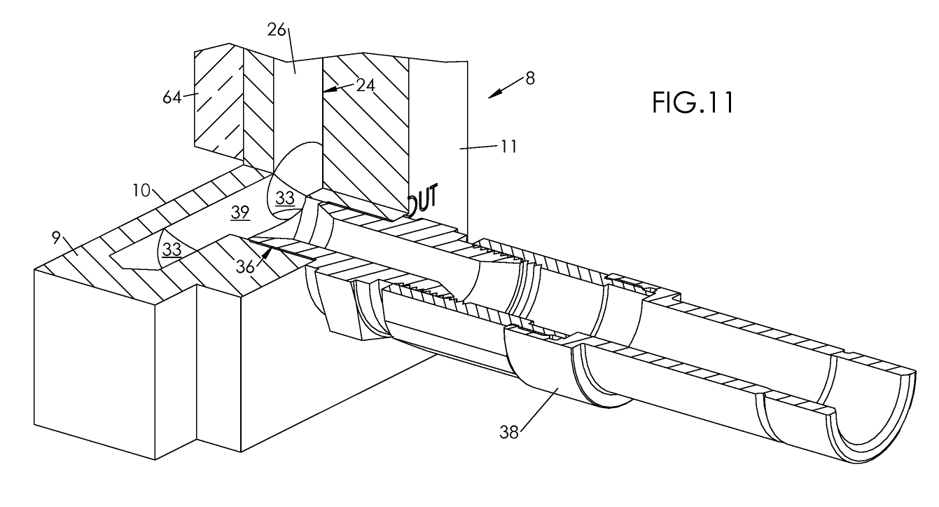

As depicted on FIG. 10, the main body 9 is provided with through holes 57 which put the desiccation chamber 55 into fluid communication with the front housing 15. The desiccation chamber 55 is at least partly filled with a desiccant 58, such as silica gel or any equivalent substance, e.g. calcium sulfate or calcium chloride. Replacement of the saturated desiccant 58 by fresh desiccant may be achieved through a removable cap 59 screwed onto the add-on case 56 and sealingly tightened thereto. Sealing joints (in black on FIG. 10) are preferably sandwiched between the add-on case 56 and the rear face 11 of the main body 9, and also between the cap 59 and the add-on case 56.

In a preferred embodiment depicted on the drawings, another confinement element is a lower reflector 60 mounted below the light emitting assembly 21.

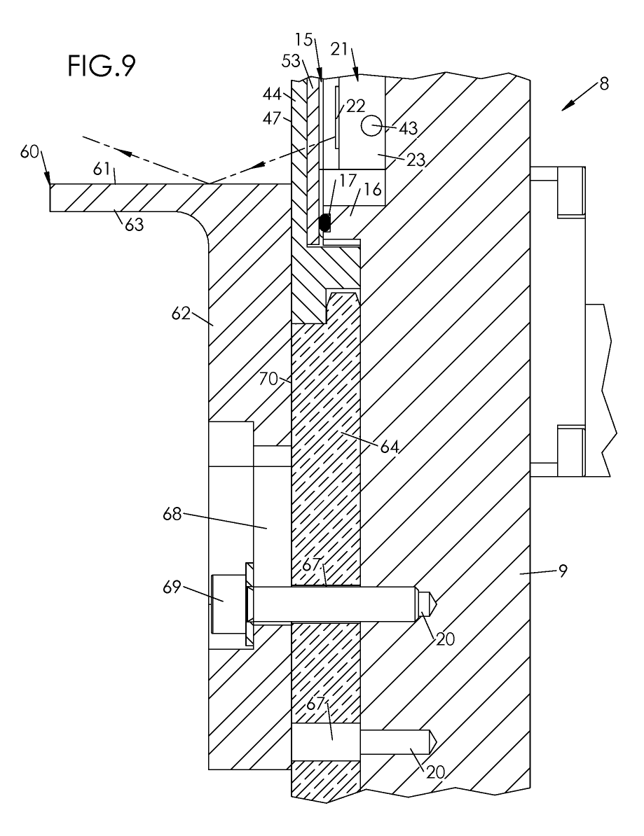

One confinement face of this lower reflector 60 is an optically reflecting upper face 61 oriented upwards. This upper face 61 serves to close the cavity 7 downwards below the parisons 2 in order to limit propagation of the radiation by reflecting it towards the bottoms 4 of the parisons 2, when those are preforms, (as illustrated by the dashed lines of FIG. 9), thereby increasing efficiency of the processing unit 1. For the sake of clarity, the upper face 61 is made visible in FIG. 5 by means of a shaded pattern.

The lower reflector 60 is preferably made of a thermally conductive material, such as a steel alloy, a copper alloy or an aluminum alloy.

The optically reflective properties of the upper face 61 may be achieved by a polishing or a coating operation, e.g. by physical vapor deposition (PVD). The coating material may be silver, platinum, aluminum or even gold.

As depicted on FIG. 3, the lower reflector 60 comprises a vertical lower section 62, and a horizontal upper section 63 which protrudes frontwards from an upper end of the lower section 62 and which forms or carries the reflecting upper face 61.

In one preferred embodiment, to make the processing unit 1 adjustable to parisons 2, more specifically preforms, of different sizes (i.e. heights), the lower reflector 60 is mounted onto the main body 9 through a setting plate 64. In order to allow vertical adjustment of the vertical position of the lower reflector 60 with respect of the main body 9, the setting plate 64 is provided with runners 65 (e.g. formed by lateral grooves), whereas the lower reflector is provided with complementary ribs 66 protruding backwards from the lower section 62, in sliding cooperation with the runners 65.

The setting plate 64 is made of a thermally conductive material, such as a steel alloy, a copper alloy or an aluminum alloy.

The setting plate 64 is provided with a series of through holes 67 coaxial with the threaded blind holes 20 of the main body 9; the lower reflector 60 is provided with a pair of elongated through holes 68 formed in the lower section 62 and facing the trough holes 67 of the setting plate 64 and the threaded blind holes 20 of the main body 9.

The setting plate 64 is fixed to the main body 9 by means of a pair of screws 69 (or any other suitable fixation means providing tight contact, such as a thermal glue) which come in helical cooperation with a pair of threaded blind holes 20 of the main body 9. The lower reflector 60 is fixed to the main body 9 with the setting plate 64 sandwiched between the lower reflector 60 and the main body 9, by means of a pair of screws 69 which come in helical cooperation with a pair of threaded blind holes 20 of the main body 9 through a pair of through holes 67 of the setting plate 64. A raw setting of the vertical position of the lower reflector 60 with respect of the main body 9 is achieved by choosing the threaded blind holes 20 in which the screws are inserted. Further fine setting of the vertical position of the lower reflector 60 is achieved by vertically sliding the lower reflector 60 with respect of the setting plate 64 before tightening the screws 69. Washers may be interposed between the screws 69 and the lower reflector 60 in order to distribute stresses.

Tightening the screws 69 against the lower reflector 60 provides tight contact between, on the one hand, the lower reflector 60 and a front face 10 of the setting plate 64 and, on the other hand, the setting plate 64 and the front face 10 of the main body 9. Such a tight contact ensures thermal contact between the main body 9 and the lower reflector 60 via the setting plate 64, which serves as a thermal bridge between the main body 9 and the lower reflector 60.

Therefore, thermal regulation of the main body 9 provides thermal regulation of the lower reflector 60, and more specifically of the reflecting upper face 61.

The setting plate 64 may act as a confinement element, in case the lower reflector 60 is fixed thereto is such a low position (e.g. when parisons 2 are of greater length) that the front face 70 of the setting plate 64 partly protrudes upwards from the reflecting upper face 61 and, therefore, faces a lower portion of the parisons 2, as illustrated on FIG. 5B. The confinement face of the setting plate 64 is the front face 70, which is optically reflecting and oriented frontwards. The optically reflective properties of the front face 70 may be achieved by a polishing or a coating operation, e.g. by physical vapor deposition (PVD). The coating material may be silver, platinum, aluminum or even gold. The front face 70 serves to reflect radiation from the heating modules 8 of the opposite sidewall 6 towards the parisons 2. Front face 70, used as confinement face is made visible in FIG. 5B by means of a shaded pattern.

Another confinement element is an upper absorber 71 mounted above the light emitting assembly 21. One main function of this upper absorber 71 is to limit upward propagation of the radiation outside the cavity 7 of the processing unit 1, in order to protect the surroundings and personnel from possible damage due to infrared light.

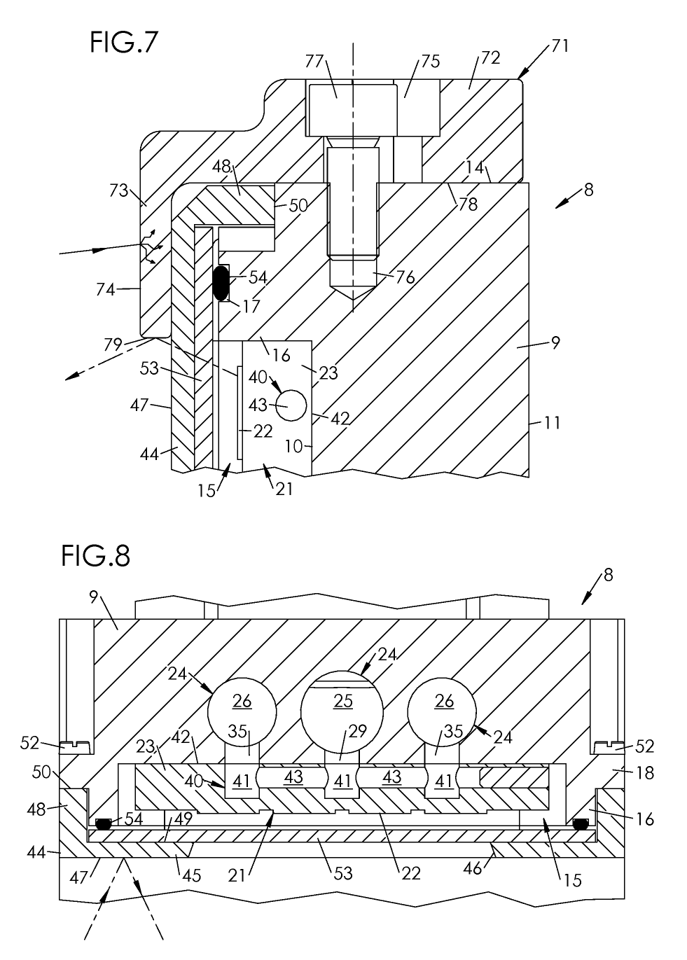

As depicted on FIG. 3, FIG. 4 and FIG. 7, the upper absorber 71 is L-shaped when viewed laterally, and comprises a horizontal upper section 72 and a vertical front section 73 which vertically protrudes from the upper section 72, at a front edge thereof.

The upper absorber 71 is made of a thermally conductive material, such as a steel alloy, a copper alloy or an aluminum alloy.

One confinement face of the upper absorber 71 is an optically absorbing front face 74, oriented frontwards, of the front section 73. The front face 74 may be made optically absorbing by means of an absorbing coating such as a black paint. The front face 74 absorbs at least part of the incident radiation emitted by the opposite sidewall 6, as suggested by the broken arrows on FIG. 7. For the sake of clarity, the front face 74 is made visible in FIG. 5 by means of a honeycomb pattern.

The upper section 72 is provided with lateral through holes 75 facing threaded blind holes 76 formed in the upper edge 14 of the main body 9. The upper absorber 71 is fixed to the main body 9 by means of screws 77 (or any other suitable fixation means providing tight contact, such as a thermal glue) which come in helical cooperation with the threaded blind holes 76 through the through holes 75. Tightening the screws 77 against the upper absorber 71 provides tight contact between a lower face 78 the upper absorber 71 and the upper edge 14 of the main body 9. Such a tight contact ensures thermal contact between the main body 9 and the upper absorber 71. Therefore, thermal regulation of the main body 9 provides thermal regulation of the upper absorber 71. It shall be noted that, since tight contact between the upper absorber 71 and the main body 9 is mainly provided sidewise, i.e. substantially above the discharge channels 26, most of the heat extracted from the upper absorber 71 goes to the fluid flowing in the discharge channels 26. In any case temperature of the fluid flowing in the intake channel to cool the light emitting assembly 21 is not (or not much) affected by the heat extracted from the upper absorber 71.

As depicted on FIG. 5 and FIG. 7, the front section 73 of the upper absorber 71 partly covers the reflector frame 44 above the front housing 15. As illustrated on FIG. 7, the through holes 75 are elongated in order to allow for horizontal adjustment of the position of the upper absorber 71 to adapt to the size of the preform neck 5, when the parison is a preform.

In one particular embodiment, another confinement face of the upper absorber 71 is an optically reflective lower edge 79 of the front section 73, oriented downwards, positioned in the vicinity of an upper edge of the light emitting assembly 21. The optically reflective properties of the lower edge 79 may be achieved by a polishing or a coating operation, e.g. by physical vapor deposition (PVD). The coating material may be silver, platinum, aluminum or even gold.

The lower edge 79 of the front section 73 serves to reflect towards the cavity 7 part of the radiation emitted by the close infrared sources of the light emitting assembly 21, as suggested by the dashed lines of FIG. 7.

The processing module 8 operates as follows.

The light emitting assembly 21 is powered by an electric supply line (not shown) according to a predetermined pattern corresponding to a desired parison (preform) processing profile.

Simultaneously, fluid at moderate temperature (e.g. comprised between 10° C. and 25° C., and for example of about 15° C.) is supplied to the fluidic circuit 24 through the intake nozzle 32. The fluid flows into the intake channel 25, passes through the intake holes 29, flows into the fluid distribution circuit 40 where it exchanges heat with the substrate 23, whereby temperature of the substrate 23 is regulated and maintained at an approximately constant temperature (of about 25° C.).

The thus heated fluid exits from the fluid distribution circuit 40 through the discharge holes 35 and flows through the discharge channels 26 where it further exchanges heat with the confinement elements 44, 60, 71 heated by the electromagnetic radiation.

More precisely, heat is withdrawn from the reflector frame 44 through the front face 10 of the main body 9, in thermal contact with the rear edge 50 of the rim 48. As the discharge channels 26 are located in the vicinity of the lateral faces 12 of the main body 9 (and hence in the vicinity of the rims 48), thermal regulation of the reflector frame 44 (at a temperature comprised between 30° C. and 40° C.) is mainly achieved by the fluid flowing in the discharge channels 26.

Heat is withdrawn from the lower reflector 60 through the front face 10 of the main body 9, in thermal contact (via the setting plate 64 acting as a thermal bridge) with the lower section 62 of the lower reflector 60. Thermal regulation of the lower reflector 60 and setting plate 64 (at a temperature comprised between 25° C. and 40° C.) is mostly achieved by the warmed (but still at a temperature lower than that of the lower reflector 60) fluid flowing in the discharge channels 26.

Heat is withdrawn from the upper absorber 71 through the upper edge 14 of the body 9, in thermal contact, through the lower face 78, with the upper section 72. The fluid flowing in the discharge channels 26 exchanges heat with the upper absorber 71 via the main body 9.

Accordingly, the confinement elements 44, 60, 71 are maintained, in operation, at a temperature close to atmospheric temperature. The processing module 8 (and hence the whole processing unit 1) therefore has a low thermal inertia, whereby:
when switched on, the processing unit 1 is quickly operational;
when switched off, the processing unit 1 is quickly ready for maintenance,
the confinement elements 44, 60, 71 are not subject to thermal fatigue and hence have longer life span;
optical properties of the confinement elements 44, 60, 71 are constant, and hence efficiency and security of the processing unit 1 is increased.

1. Electromagnetic processing module (8) including:
a main body (9) having a front face (10),
a light emitting assembly (21) including a plurality of light emitting sources, the light emitting assembly (21) being such mounted onto the main body (9) as to radiate frontwards,
a fluidic circuit (24) provided within the main body (9) for thermal regulation of the light emitting assembly (21);
at least one confinement element (44, 60, 64, 71) made of a material opaque to the emitted light and having a confinement face (47, 61, 74, 79) exposed to the emitted light,
wherein the fluidic circuit (24) comprises at least one intake channel (25) formed in the main body (9) and at least one discharge channel (26) formed in the main body (9), said confinement element (44, 60, 64, 71) being mounted onto the main body (9) so as to be in thermal contact therewith, whereby thermal regulation of the confinement face (47, 61, 74, 79) is provided by the fluidic circuit (24).

2. Processing module (8) according to claim 1, wherein the confinement element (44, 60, 64, 71) is fixed to the main body (9) by means of screws or any other fixation means providing tight contact.

3. Processing module (8) according to claim 1, wherein one confinement element is a reflector frame (44) surrounding the light emitting assembly (21), and wherein one confinement face of the reflector frame (44) is an optically reflecting face (47) oriented frontwards.

4. Processing module (8) according to claim 3, wherein the reflector frame (44) has a rear edge (50) opposite the reflecting face (47), said rear edge (50) being in contact with the front face (10) of the main body (9).

5. Processing module (8) according to claim 1, wherein one confinement element is a lower reflector (60) mounted below the light emitting assembly (21), and wherein one confinement face of the lower reflector (60) is an optically reflecting face (61) oriented upwards.

6. Processing module (8) according to claim 5, wherein the lower reflector (60) is mounted onto the main body (9) through a setting plate (64) provided with means for adjusting vertical position of the lower reflector (60) with respect of the main body (9), said setting plate (64) serving as thermal bridge between the main body (9) and the lower reflector (60).

7. Processing module (8) according to claim 6, wherein the setting plate (64) has an optically reflecting face (70) oriented frontwards.

8. Processing module (8) according to claim 1, wherein one confinement element is an upper absorber (71) mounted above the light emitting assembly (21), and wherein one confinement face of the upper absorber (71) is an optically absorbing face (74) oriented frontwards.

9. Processing module (8) according to claim 8, wherein the upper absorber (71) has an optically reflective lower edge (79) oriented downwards, positioned in the vicinity of an upper edge of the light emitting assembly (21).

10. Processing module (8) according to claim 1, wherein the light emitting assembly (21) is received in a hollow front housing (15) formed in the front face (10) of the main body (9).

11. Processing module (8) according to claim 10, wherein, said intake channel (25) is opening, on the one hand, in the front housing (15) through an intake hole (29) and, on the other hand, on a rear face (11) of the main body (9) through an inlet port (30).

12. Processing module (8) according to claim 11, wherein the discharge channel (26) is parallel to the intake channel (25), said discharge channel (26) opening, on the one hand, in the front housing (15) through a discharge hole (35) and, on the other hand, on the rear face (11) of the main body (9) through an outlet port (36).

13. Processing module (8) according to claim 12, wherein the fluidic circuit (24) comprises a pair of discharge channels (26) formed on each side of the intake channel (25).

14. Processing module (8) according to claim 1, wherein the light emitting sources are designed for emitting in the infrared range.

15. Processing module (8) according to claim 14, wherein the light emitting sources are infrared laser diodes.

16. Processing module (8) according to claim 15, wherein the light emitting sources are VCSEL diodes.

17. Processing unit (1) for the electromagnetic processing of parisons made of plastic, said processing unit (1) comprising a series of adjacent processing modules (8) according to claim 1.

18. Processing module (8) according to claim 2, wherein one confinement element is a reflector frame (44) surrounding the light emitting assembly (21), and wherein one confinement face of the reflector frame (44) is an optically reflecting face (47) oriented frontwards.

19. Processing module (8) according to claim 2, wherein one confinement element is a lower reflector (60) mounted below the light emitting assembly (21), and wherein one confinement face of the lower reflector (60) is an optically reflecting face (61) oriented upwards.

20. Processing module (8) according to claim 3, wherein one confinement element is a lower reflector (60) mounted below the light emitting assembly (21), and wherein one confinement face of the lower reflector (60) is an optically reflecting face (61) oriented upwards.
